(19) United States
(12) Patent Application Publication
(10) Pub. No.: US 2022/0151282 A1
(43) Pub. Date: May 19, 2022

(54) METHOD AND DEVICE FOR 3D-PRINTING OF FOOD PRODUCTS

(71) Applicant: Deutsches Institut für Lebensmitteltechnik e.V., Quakenbrück (DE)

(72) Inventors: Volker Lammers, Quakenbrück (DE); Lars Leonhardt, Quakenbrück (DE); Jens Schröder, Quakenbrück (DE); Josef Müller, Quakenbrück (DE)

(21) Appl. No.: 17/469,309

(22) Filed: Sep. 8, 2021

(30) Foreign Application Priority Data
Sep. 10, 2020 (DE) 102020211412.9

(51) Int. Cl. A23P 30/20

(52) U.S. Cl. CPC A23P 30/20

(57) ABSTRACT

A process for producing dimensionally stable food products continuously introduces food raw materials and water into the housing of an extruder. At least one screw is arranged in the housing. The screw is rotated to generate a mixture of the food raw materials in the housing. A section ahead of the outlet of the housing is controlled to heat the mixture to at least 60° C. to produce a cooked mass from the mixture. The cooked mass is discharged from the outlet and deposited on a carrier. The carrier is moved in a controlled manner relative to the outlet to produce form-stable food products on the carrier. The depositing of the cooked mass takes place in directly adjacent lanes into mass strips, which preferably lie in at least two planes on top of one another. .

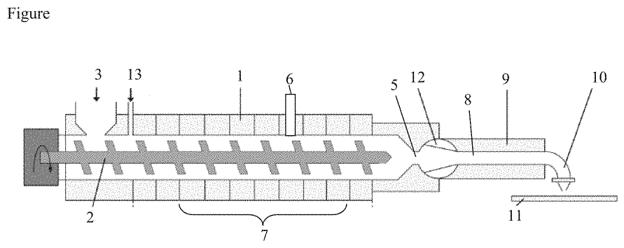

### PRIORITY CLAIM

The present application claims the priority under 35 U.S.C. §119, of German patent application 10 2020 211 412.9, filed on Sep. 10, 2020.

### FIELD

A field of the invention are processes and a devices suitable for use in the process, by which food products are produced from food raw materials, which food products are preferably compact, resp. have no air inclusions.

### BACKGROUND

EP 3 524 068 A1 describes a plunger that presses flour-based prefabricated dough out of a cylinder, and the resulting filament can be deposited in several layers, one on top of the other, following a superficial heating with air at 60 to 90° C.

EP 3 270 716 B1 describes a process for the production of a meat substitute strand by extruding a mixture of at maximum 4 wt.-% flour, 40 to 70 wt.-% water and 15 to 35 wt.-% plant-based protein through a cooling die, wherein 2 to 15 wt.-% oil and/or fat are introduced downstream of the extruder inlet.

U.S. Pat. No. 6,280,785 B1 for 3D printing of food mass deposits a mass strand from a dispensing head in multiple layers onto a movable carrier. Examples 1 to 3 also mention heating the masses to be extruded to 60 to 70° C.

WO 2015/020660 A1 describes a process for the production of an extruded meat substitute, wherein an extruded mass is divided into at least two separate partial streams prior to depositing.

At least one of the partial streams can be passed through a pump. The temperature of the mass can be adjusted to a temperature between 20 and 180° C.

### BRIEF DESCRIPTION OF THE DRAWINGS

The process and the device are explained by an example and with reference to the FIGURE, which schematically shows

FIGURE—a preferred device in longitudinal sectional view through an extruder.

### SUMMARY OF THE INVENTION

A preferred device and a process produce, preferably continuously, dimensionally stable food products are produced from food raw materials without using a hollow mold for shaping. Preferably, the process produces dimensionally stable food products from food raw materials continuously and without intermediate storage, which food products are preferably compact, resp. have no air inclusions, and the device is suitable for use for the process. Further preferably, the process shall produce dimensionally stable food products in a finished shape, e.g. without a shaping recess surrounding the food product and without cutting the food products.

### DETAILED DESCRIPTION OF THE PREFERRED EMBODIMENTS

In a preferred process, a pumpable mass is produced from the food raw materials, preferably continuously, which pumpable mass has an elevated temperature and is immediately subsequently deposited on a carrier and cools on the carrier and thereby solidifies. Preferably, the complete mixture of the raw materials forms the mass and the food products consist of the mass, so that e.g. no added water is separated off during the process. Optionally, the food products can be surface coated and/or heated subsequently to the depositing and cooling.

The process has the advantage that it produces dimensionally stable food products on a carrier from a mass having a high protein content and optionally having a low starch content, which carrier preferably is flat, e.g. a plate or a conveyor belt, and the process is carried out without using a hollow mold to shape the pumpable mass.

The invention achieves the object by the features of the claims and in particular provides a process including the steps of
continuously introducing all food raw materials and water into the housing of an extruder in which at least one screw is arranged,
rotating the at least one screw in the housing to generate a mixture from the food raw materials in the housing,
temperature-controlling the housing in at least a section ahead of the outlet of the housing for heating the mixture to at least 60° C., or at least 70° C., or at least 80° C., or at least 90° C., e.g. in each case to 110° C., preferably to at maximum 100° C. or to at maximum 95° C., to generate a cooked mass from the mixture,
discharging the cooked mass from the outlet of the extruder housing,
depositing the cooked mass on a carrier which is movable in a controlled manner relative to the outlet, to produce dimensionally stable food products on the carrier,
wherein optionally a temperature-controlled conduit is connected to the outlet of the extruder housing, which conduit is temperature-controlled to keep the cooked mass at a temperature of 60 to 100° C., preferably at 70 to 95° C., in particular at the temperature that the mass has when exiting from the extruder housing,
wherein optionally a pump is connected to the outlet of the extruder housing, preferably between the outlet of the extruder housing and a temperature-controlled conduit,
wherein optionally the carrier is movable in a controlled manner in two or three dimensions, and the extruder housing, the optional pump connected to the outlet of the extruder housing, and the optional temperature-controlled conduit that is connected to the outlet of the extruder housing or to the pump are fixed,
wherein preferably the food raw materials are fed into the extruder housing at the inlet end of the extruder, and the added water is fed into the extruder housing at least completely or partially through a feed port which is arranged downstream of the inlet end, wherein a portion of the fed water can be admixed to the food raw materials before feeding into the inlet end,
wherein the depositing of the cooked mass takes place in directly adjacent lanes into mass strips which preferably lie on top of one another in at least two planes.

The mixture or the cooked mass consists, minus the water evaporating from the surface. Therein, it has shown that, after cooling to room temperature in room air, the cooked mass exhibits only slight to no weight loss due to evaporating water.

Optionally, the food product can subsequently be superficially coated and/or superficially heated, e.g. by hot-air treatment or deep-frying.

Because the cooked mass exits from the outlet of the extruder housing, or from a temperature-controlled conduit connected thereto, and is deposited on the carrier at a temperature of at maximum 100° C., preferably below 100° C., the food product also consists of the mass having substantially the same water content.

It has shown that a mixture, or resp. a cooked mass produced therefrom in the extruder, at the exit temperature, when deposited along lanes to form adjacent mass strips on the carrier, results in a dimensionally stable and compact or substantially air bubble-free food product. This is attributed to the fact that the cooked mass has a high protein content, e.g. a protein content of 15 to 50 wt.-%. The mixture and the cooked mass produced therefrom in the extruder preferably contains or consists of

15 to 50 wt.-% protein, which is preferably plant-based protein,

0 to 5wt.-% carbohydrates, which are in particular plant-based starch,

optionally 0 to 15 wt.-% additives, and

balance water, preferably 85 to 50 wt.-% water.

The additives are e.g. selected from the group including table salt, flavoring, colorants, fats and oils, preservatives, plant-based fibers, thickeners, and mixtures of at least two of these. Preferably, the additive does not include a thickener and the mixture is free of thickeners selected from natural and modified polysaccharides, e.g. carrageenan, guar gum, carboxymethyl cellulose, cellulose, starch, modified starch, locust bean gum and gelatin. Preferably, the mixture is free of added glycerol and/or sucrose.

Water-soluble additives can be fed in admixture with the plant-based protein and/or in admixture with water, e.g. into the inlet end of the extruder or through a feed port which is arranged downstream thereof. Additives can generally be fed through at least one feed port which is arranged downstream of the inlet end of the extruder.

Plant-based protein can e.g. be at least one of plant-based protein isolate, plant-based protein concentrate, and/or plant-based flour, e.g. pumpkin seed flour, cereal protein, in particular oat protein, field bean protein, pea protein, soy protein, or sunflower protein. Preferably, the plant-based protein is a flour, protein concentrate, or protein isolate, e.g. of pumpkin seed flour, of field bean, of pea, of sunflower, or is protein isolate of cereals, in particular of oats.

The components of the mixture or resp. of the cooked mass add up to 100 wt.-% with water.

Preferably, a pump is connected to the outlet of the extruder housing, which pump is controlled to convey cooked mass only during depositing cooked mass for a single food product, and optionally does not convey mass during a movement of the carrier relative to the outlet in an area of the single food product, and/or does not convey mass during a movement of the carrier relative to the outlet between areas of the carrier where mass is deposited, to produce separate food products, or resp. to prevent the formation of threads or droplets between separate food products.

Fat and/or oil can be introduced into the inlet end of the extruder housing in liquid or solid form in admixture with the plant-based protein, or can be fed into the extruder housing separately from the plant-based protein through a second feed port which is arranged downstream of the inlet end, optionally ahead or downstream of a feed port for water. Further optionally, fat soluble flavoring, e.g. meat flavoring, can be fed in admixture with fat and/or oil.

The extruder housing is heated, preferably having a double jacket flowed-through by a temperature-control medium, or an electrically heated housing. The extruder housing is heated in at least one section, which is preferably arranged immediately ahead of the outlet, to heat the mass to a temperature of 60 to 100° C., preferably 70 to 95° C., and further preferably, the extruder housing in the area of the inlet end, further optionally in the area of an optional feed port for water, is temperature-controlled to a temperature of below 60° C. or below 50° C., or is not temperature-controlled, resp. has no double jacket.

The depositing of the cooked mass in lanes directly adjacent to one another is preferably carried out with a movement of the carrier relative to the outlet of the extruder housing or resp. to the heated conduit, the movement being at a speed which, for the exiting mass flow of the cooked mass, produces mass strips which lie directly adjacent to one another and on top of one another in at least two planes, and which fuse with one another or adhere to one another along their contact surfaces.

The process has the advantage that the mass from which mass strips are deposited on the carrier, which fuse without further ado to form dimensionally stable food products, without further processing by pressing or cutting, is produced immediately beforehand and preferably continuously from its constituents and is heated in the process. This allows the process to proceed continuously on the basis of raw materials without storing an intermediate product. The device is therefore set up for a process that does not firstly produce a food mass which is then formed using separate machines for shaping.

Therein, dimensionally stable food products obtainable by the process according to the invention are dimensionally stable in particular at 0 to 100° C., preferably between 20° C. and 95° C., so that they can e.g. be heated by heating in a frying pan, by microwave irradiation, by infrared irradiation or by applying an electric current, while substantially retaining their shape.

The device suitable for use in the process has an extruder housing in which at least one driven screw is arranged, the extruder housing having an inlet end for the introducing of protein, an outlet lying opposite in the conveying direction, and optionally having at least one feed port for water, further optionally at least one second feed port, e.g. for fat and/or oil, which second feed port is arranged downstream of the feed port for water, wherein the extruder housing has, at least in a section directly adjacent to its outlet, a temperature-control device, in particular a double jacket flowed-through by a temperature-control medium, which double jacket is set up to heat the mass to a temperature of 60 to 100° C. during rotation of the at least one screw. A temperature-controlled conduit is preferably connected to the outlet of the extruder, which conduit is e.g. set up to keep the cooked mass at the temperature it has when exiting from the extruder housing. Alternatively, the temperature-controlled conduit can be temperature-controlled to cool the cooked mass to a temperature below the temperature the mass has when exiting from the extruder housing, e.g. to cool the mass to a temperature of below 10° C. to below 30° C. or to below 40° C. or to below 50° C. the temperature the mass has when exiting from the extruder housing. Further preferably, a pump is connected between the temperature-controlled conduit and the extruder housing, which pump is controlled to convey cooked mass from the extruder while the cooked mass is deposited in mass strips on the carrier, and which pump is set up to not convey mass when the carrier moves away from a position in which a food product has been produced. The extruder can e.g. be a single screw extruder, preferably a twin screw extruder or a planetary roller extruder.

The pump, which e.g. is a gear pump, has the advantage that after a period in which it does not convey any mass, by being controlled to convey it conveys in a controlled manner when subsequently conveying cooked mass. Therein, the at least one screw of the extruder can be driven to the same number of revolutions or to a reduced number of revolutions when the pump is not conveying mass and when it is conveying mass. Therein, the reduced number of revolutions is one at which the at least one screw still rotates at at least 100 RPM, e.g. reduced by 10 to 50% of the number of revolutions at which the at least one screw rotates when the pump is conveying. Continued rotation of the at least one screw, particularly even when the pump is controlled not to convey, preserves the properties of the mass in the extruder and e.g. reduces a higher thermal load on the mass at the extruder housing. In contrast to a pump, a valve connected to the outlet of the extruder would have the disadvantage that, when opened following an interruption in the discharging of cooked mass, the latter would briefly discharge in a jerky manner and with a higher mass flow than after continuous discharge of the mass.

The figure shows an extruder, in the housing 1 of which a rotationally driven screw 2 is arranged and which has an inlet end 3 for solids, in particular protein, optionally in admixture with a portion of the water of the mixture. In the conveying direction of the screw 2, downstream of the inlet end 3, a feed port 13 is connected to the housing 1, through which feed port 13 liquid components of the mixture, in particular water and/or fat above its melting temperature and/or oil, can be introduced. Between the feed port 13 and the outlet 5, an optional second feed port 6 is connected to the housing 1, e.g. for introducing fat and/or oil, optionally in admixture with fat-soluble flavoring.

As a temperature-control device, the housing has a double jacket 7 which is divided into sections through which temperature-control medium can flow separately.

According to an optional embodiment, a temperature-controllable conduit 8 is connected to the outlet 5, which conduit 8 for temperature control has a double jacket 9 through which temperature-control medium can flow. Through this conduit 8, the outlet 5 of the extruder housing 1 is displaced, wherein by the temperature control the cooked mass produced in the extruder can be kept in a controlled manner at a temperature which is at or slightly below its exit temperature from the housing 1. A pump 12 is connected between the temperature-controllable conduit 8 and the outlet 5 of the extruder, as is generally preferred. Generally optionally, a nozzle 10 can be arranged terminally on the conduit 8 as an outlet. Below the outlet, herein formed by the nozzle 10, a carrier 11 is arranged which is movable in a controlled manner in two, preferably in 3 dimensions, in order to, during movement of the carrier 11, deposit the cooked mass exiting from the outlet on the carrier 11 along lanes in mass strips which lie directly adjacent to one another and which lie one on top of the other in at least two planes.

### EXAMPLE

### Production of a Dimensionally Stable Compact Food Product

As a plant-based protein, pea protein isolate, approx. 85 wt.-% protein content, at 25 wt.-% of the mixture was continuously introduced into the inlet end 3 of a twin screw extruder and water at 75 wt.-% of the mixture was continuously introduced through a feed port 13 connected downstream of the inlet end 3. The total flow rate of mixture through the extruder could be adjusted in the range of 4 to 20 kg/h. The housing 1 of the extruder was temperature-controlled to about 100° C. by a double jacket through which a water-glycol mixture flowed. This temperature-controlled double jacket extended between the feed port 13 for water and the outlet 5 of the extruder. A temperature-controlled double-walled conduit 8 was directly connected to the outlet 5 of the extruder, the outlet of which conduit 8 was arranged as a nozzle 10 above a table 11 movable in a controlled manner in three dimensions. The double jacket of the conduit 8 was temperature-controlled to approx. 95 to 100° C. The table 11 was controlled in such a way that the mass strip exiting from the outlet 10 was deposited by a reciprocating movement of the table 11 in directly adjacent mass strips and then again in one or two further layers of directly adjacent mass strips. This arrangement of mass strips from the cooked mass formed the dimensionally stable food product. It was compact or had essentially no air inclusions. The surface of this arrangement of mass strips, which surface lied opposite to the carrier 11, showed a corrugation, which was due to the mass strips which were deposited closely next to one another and fused.

1. Process for the production of dimensionally stable food products, the process having the steps of
continuously introducing all of the food raw materials and water into the housing of an extruder having at least one screw arranged therein,
rotating the at least one screw in the housing in order to produce a mixture of the food raw materials in the housing,
temperature-controlling the housing in at least a section ahead of the outlet of the housing for heating the mixture to at least 60° C. up to at maximum 110° C. in order to produce a cooked mass from the mixture,
discharging the cooked mass from the outlet of the extruder housing,
depositing the cooked mass on a carrier, which is movable in a controlled manner relative to the outlet, in directly adjacent lanes as mass strips which lie on top of one another in at least two planes, in order to produce dimensionally stable food products on the carrier, characterized in that a temperature-controlled conduit is connected to the outlet of the extruder housing, which conduit is temperature-controlled to keep the cooked mass at the temperature which the mass has when exiting from the extruder housing, in that a pump is connected between the outlet of the extruder housing and the temperature-controlled conduit, which pump is controlled to convey only during depositing cooked mass onto the carrier and to not convey mass during movement of the carrier relative to the outlet between areas of the carrier in which mass is deposited, and in that the at least one screw of the extruder is driven at a lower number of revolutions when the pump is not conveying mass than the number of revolutions for which the at least one screw is driven when the pump is conveying mass.

2. Process according to claim 1, characterized in that at the inlet end of the extruder housing, 15 to 50 wt.-% protein is introduced as one of the food raw materials, and the water is introduced into the extruder housing at 50 to 85 wt.-%, each in relation to the total mixture, wherein a portion of the introduced water can be admixed with the food raw materials prior to introducing into the inlet end.

3. Process according to claim 1, characterized in that the carrier has a flat surface in the area in which cooked mass is deposited thereon.

4. Process according to claim 1 that is carried out with an extruder housing in which at least one driven screw is arranged, the extruder housing having an inlet end for introducing protein, an outlet lying opposite in the conveying direction, and at least one feed port for water, at least one second feed port arranged downstream for feeding fat and/or oil, wherein the extruder housing, at least in one section immediately adjacent to its outlet, has a temperature-control device which is set up to heat the mass to a temperature of 60 to 100° C. during rotation of the at least one screw, wherein a temperature-controlled conduit is connected to the outlet of the extruder, which conduit is set up to keep the cooked mass at the temperature which it has when exiting from the extruder housing, and wherein a pump is connected between the temperature-controlled conduit and the extruder housing, which pump is controlled to convey cooked mass from the extruder while the cooked mass is deposited in mass strips on a carrier, and which pump is set up not to convey mass when the carrier moves away from a position in which a food product has been produced, wherein a carrier, which is movable in a controlled manner in at least two dimensions, is arranged below the outlet of the temperature-controlled conduit, characterized in that the at least one screw of the extruder is driven to a lower number of revolutions when the pump is not conveying mass than the number of revolutions at which the at least one screw is driven when the pump is conveying mass.

5. Device for use in a process according to claim 1, the device having an extruder housing in which at least one driven screw is arranged, an inlet end for introducing protein, an outlet lying opposite in the conveying direction, and at least one feed port for water, at least one second feed port arranged downstream for feeding fat and/or oil, wherein the extruder housing, at least in a section immediately adjacent to its outlet, has a temperature-control device which is set up to heat the mass to a temperature of 60 to 100° C. during rotation of the at least one screw, wherein a temperature-controlled conduit is connected to the outlet of the extruder, which conduit is arranged to keep the cooked mass at the temperature which it has when exiting from the extruder housing, and a pump is connected between the temperature-controlled conduit and the extruder housing, which pump is controlled to convey cooked mass from the extruder while the cooked mass is deposited in mass strips on a carrier, and which pump is set up to not convey mass when the carrier moves away from a position in which a food product has been produced, wherein a carrier, which is movable in a controlled manner in at least two dimensions, is arranged below the outlet of the temperature-controlled conduit, characterized in that the at least one screw of the extruder is driven to a lower number of revolutions when the pump is not conveying mass than the number of revolutions at which the at least one screw is driven when the pump is conveying mass.
